(19) United States
(12) Patent Application Publication
(10) Pub. No.: US 2024/0272536 A1
(43) Pub. Date: Aug. 15, 2024

(54) ILLUMINATION SYSTEM AND PROJECTION DEVICE

(71) Applicant: Coretronic Corporation, Hsin-Chu (TW)

(72) Inventors: Yu-Hsiang Deng, Hsin-Chu (TW); Min-Chang Chang, Hsin-Chu (TW)

(73) Assignee: Coretronic Corporation, Hsin-Chu (TW)

(21) Appl. No.: 18/427,764

(22) Filed: Jan. 30, 2024

(30) Foreign Application Priority Data
Feb. 13, 2023 (CN) 202310101921.6

(51) Int. Cl. G03B 21/20

(52) U.S. Cl. CPC G03B 21/208; G03B 21/2013; G03B 21/2066

(57) ABSTRACT

An illumination system, including a first light source module, a second light source module, and a light combining module, is provided. A first beam from the first light source module is transmitted along a first direction. The light combining module changes a transmission direction of the first beam from the first direction to a second direction and then to a third direction, and the first beam leaves the light combining module. A second beam from the second light source module is transmitted along the second direction. The light combining module changes a transmission direction of the second beam from the second direction to the third direction, and the second beam leaves the light combining module. An illumination beam is formed after the first beam and the second beam leave the light combining module. A projection device is also provided.

### CROSS-REFERENCE TO RELATED APPLICATION

This application claims the priority benefit of China application serial no. 202310101921.6, filed on Feb. 13, 2023. The entirety of the above-mentioned patent application is hereby incorporated by reference herein and made a part of this specification.

### BACKGROUND

### Technical Field

The disclosure relates to an optical system and an optical device, and particularly relates to an illumination system and a projection device.

### Description of Related Art

Due to the advantages of price and volume, the design of a projection device gradually adopts a packaged laser module as a light source of the projection device. In order to further increase the brightness of an image beam, multiple sets of packaged laser modules need to be adopted in the design. However, beams generated by the sets of packaged laser modules tend to have non-uniform angular and spatial distribution after emitting from a light combining module, thereby causing the color lights of the image beam projected by the projection device to be non-uniform.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides an illumination system and a projection device, which can generate an evenly distributed illumination beam, thereby improving the color uniformity of an image beam.

Other objectives and advantages of the disclosure may be further understood from the technical features disclosed in the disclosure.

In order to achieve one, a part, or all of the above objectives or other objectives, an embodiment of the disclosure provides an illumination system, which includes a first light source module, a second light source module, and a light combining module. The illumination system is configured to provide an illumination beam. The first light source module is configured to generate a first beam. The first beam is incident on the light combining module along a first direction. The light combining module is configured to change a transmission direction of the first beam from the first direction to a second direction and then to a third direction, and the first beam leaves the light combining module along the third direction. The first direction, the second direction, and the third direction are perpendicular to each other. The second light source module is configured to generate a second beam. The second beam is incident on the light combining module along the second direction. The light combining module is configured to change a transmission direction of the second beam from the second direction to the third direction, and the second beam leaves the light combining module along the third direction. The first beam and the second beam leaving the light combining module form the illumination beam. The first beam includes at least one of a first color beam, a second color beam, and a third color beam. The second beam includes at least one of a fourth color beam, a fifth color beam, and a sixth color beam.

In order to achieve one, a part, or all of the above objectives or other objectives, an embodiment of the disclosure provides a projection device, which includes an illumination system, a light valve, and a projection lens. The illumination system includes first light source module, second light source module and light combining module. The illumination system is configured to provide an illumination beam. The light valve is disposed on a transmission path of the illumination beam to convert the illumination beam into an image beam. The projection lens is disposed on a transmission path of the image beam to project the image beam out of the projection device. The first light source module is configured to generate a first beam, and the first beam is incident on the light combining module along a first direction. The light combining module is configured to change a transmission direction of the first beam from the first direction to a second direction and then to a third direction, and the first beam leaves the light combining module along the third direction. The first direction, the second direction, and the third direction are perpendicular to each other. The second light source module is configured to generate a second beam. The second beam is incident on the light combining module along the second direction. The light combining module is configured to change a transmission direction of the second beam from the second direction to the third direction, and the second beam leaves the light combining module along the third direction. The first beam and the second beam leaving the light combining module form the illumination beam. The first beam includes at least one of a first color beam, a second color beam, and a third color beam, and the second beam includes at least one of a fourth color beam, a fifth color beam, and a sixth color beam.

Based on the above, in the illumination system or the projection device according to an embodiment of the disclosure, the light combining module is configured to change the transmission direction of the first beam from the first direction to the second direction and then to the third direction, and change the transmission direction of the second beam from the second direction to the third direction. Then, each of the first beam and second beam leaves the light combining module along the third direction. Therefore, the angular distribution and spatial distribution of the first beam and the second beam after emitting from the light combining module are symmetrical, so that the color uniformity of the illumination beam or the image beam generated by the illumination system or the projection device is better.

Other objectives, features and advantages of the disclosure will be further understood from the further technological features disclosed by the embodiments of the disclosure wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection device and an illumination system according to a first embodiment of the disclosure.

FIG. 2 is a schematic view of a projection device and an illumination system according to a second embodiment of the disclosure.

FIG. 3A is a three-dimensional schematic view of the illumination system in FIG. 2.

FIG. 3B is a schematic view of light paths of a first color beam, a fourth color beam, and a seventh color beam in the illumination system of FIG. 3A.

FIG. 3C is a schematic view of a light spot distribution formed by the beams of FIG. 3B on a light incident surface of a light homogenizing element.

FIG. 3D is a schematic view of light paths of a second color beam, a fifth color beam, and an eighth color beam in the illumination system of FIG. 3A.

FIG. 3E is a schematic view of a light spot distribution formed by the beams of FIG. 3D on a light incident surface of a light homogenizing element.

FIG. 3F is a schematic view of light paths of a third color beam, a sixth color beam, and a ninth color beam in the illumination system of FIG. 3A.

FIG. 3G is a schematic view of a light spot distribution formed by the beams of FIG. 3F on a light incident surface of a light homogenizing element.

FIG. 3H is a schematic view of a light path of a first color beam at a light guiding element in FIG. 3A.

FIG. 3I is a schematic view of light paths of a second color beam and a third color beam at a light guiding element in FIG. 3A.

FIG. 4 is a schematic view of an illumination system according to a third embodiment of the disclosure.

FIG. 5A is a three-dimensional schematic view of an illumination system according to a fourth embodiment of the disclosure.

FIG. 5B is a schematic view of light paths of a first color beam, a fourth color beam, and a seventh color beam in the illumination system of FIG. 5A.

FIG. 5C is a schematic view of a light spot distribution formed by the beams of FIG. 5B on a light incident surface of a light homogenizing element.

FIG. 5D is a schematic view of light paths of a second color beam, a fifth color beam, and an eighth color beam in the illumination system of FIG. 5A.

FIG. 5E is a schematic view of a light spot distribution formed by the beams of FIG. 5D on a light incident surface of a light homogenizing element.

FIG. 5F is a schematic view of light paths of a third color beam, a sixth color beam, and a ninth color beam in the illumination system of FIG. 5A.

FIG. 5G is a schematic view of a light spot distribution formed by the beams of FIG. 5F on a light incident surface of a light homogenizing element.

FIG. 6A is a three-dimensional schematic view of an illumination system according to a fifth embodiment of the disclosure.

FIG. 6B is a schematic view of light paths of a first color beam, a fourth color beam, and a seventh color beam in the illumination system of FIG. 6A.

FIG. 6C is a schematic view of a light spot distribution formed by the beams of FIG. 6B on a light incident surface of a light homogenizing element.

FIG. 6D is a schematic view of light paths of a second color beam, a fifth color beam, and an eighth color beam in the illumination system of FIG. 6A.

FIG. 6E is a schematic view of a light spot distribution formed by the beams of FIG. 6D on a light incident surface of a light homogenizing element.

FIG. 6F is a schematic view of light paths of a third color beam, a sixth color beam, and a ninth color beam in the illumination system of FIG. 6A.

FIG. 6G is a schematic view of a light spot distribution formed by the beams of FIG. 6F on a light incident surface of a light homogenizing element.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top”, “bottom”, “front”, “back”, etc., is used with reference to the orientation of the Figure(s) being described. The components of the disclosure may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

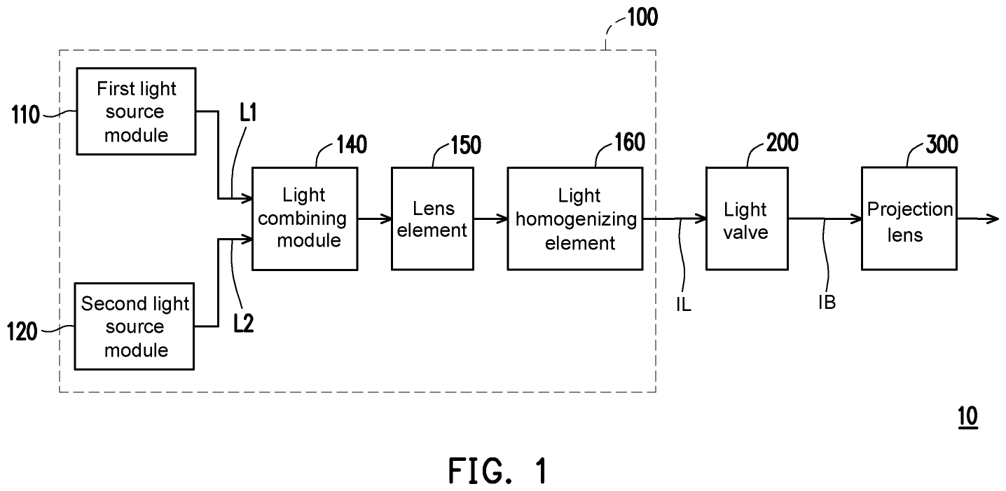

FIG. 1 is a schematic view of a projection device and an illumination system according to a first embodiment of the disclosure. Please refer to FIG. 1. An embodiment of the disclosure provides a projection device 10, which includes an illumination system 100, a light valve 200, and a projection lens 300.

In detail, the light valve 200 of the embodiment is, for example, a digital micro-mirror device (DMD), a liquid-crystal-on-silicon panel (LCOS panel), a liquid crystal panel, or other spatial light modulators. In addition, the projection lens 300 is, for example, a combination of one or more optical lens elements with optical power. The optical lens element includes, for example, various combinations of non-planar lens elements such as a biconcave lens element, a biconvex lens element, a concave-convex lens element, a convex-concave lens element, a plano-convex lens element, and a plano-concave lens element. The disclosure does not limit the form and the type of the projection lens 300.

In the embodiment, the illumination system 100 includes a first light source module 110, a second light source module 120, and a light combining module 140. The illumination system 100 is configured to provide an illumination beam IL. The light valve 200 is disposed on a transmission path of the illumination beam IL to convert the illumination beam IL into an image beam IB. The projection lens 300 is disposed on a transmission path of the image beam IB to project the image beam IB out of the projection device 10.

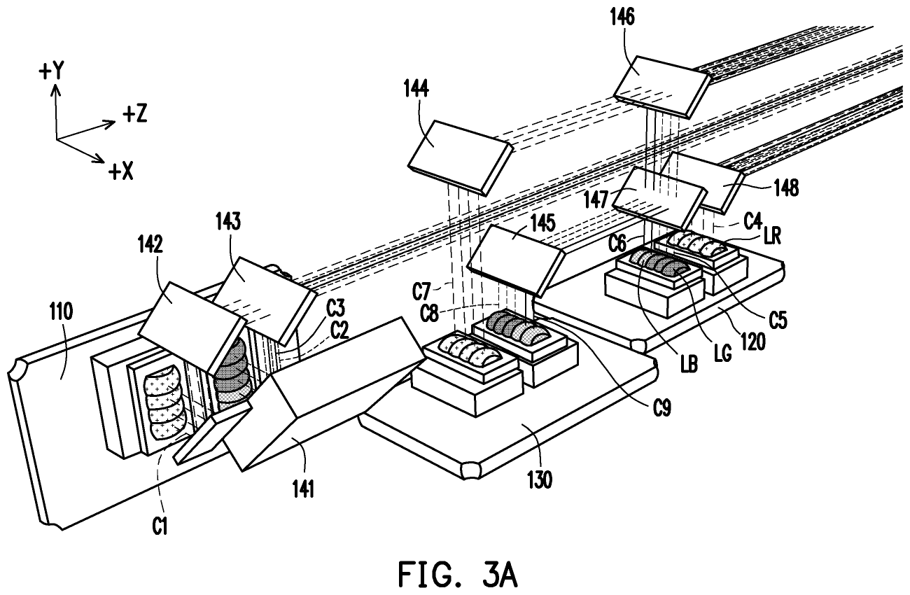

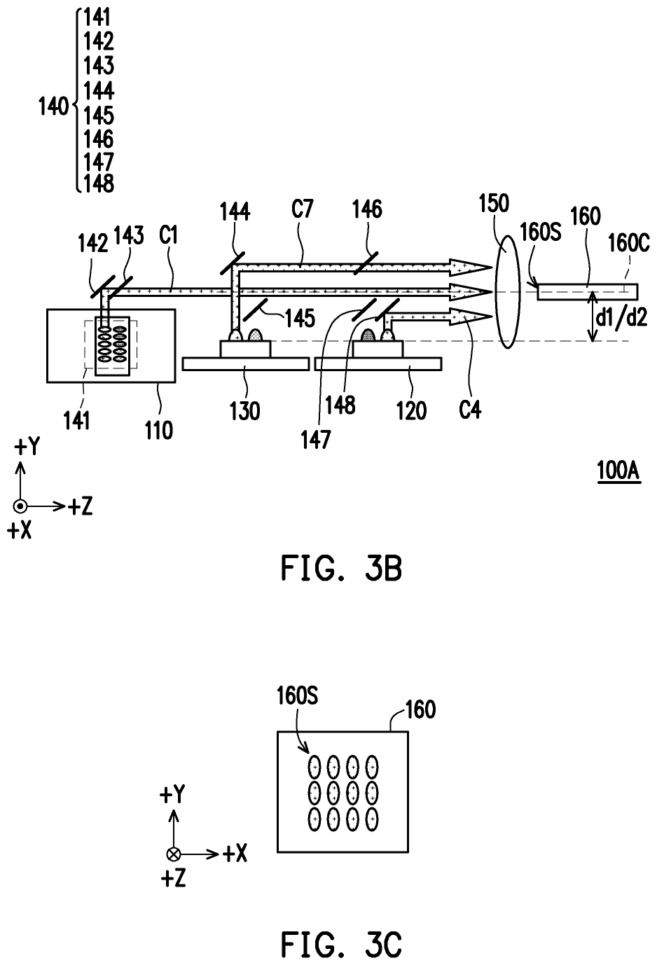

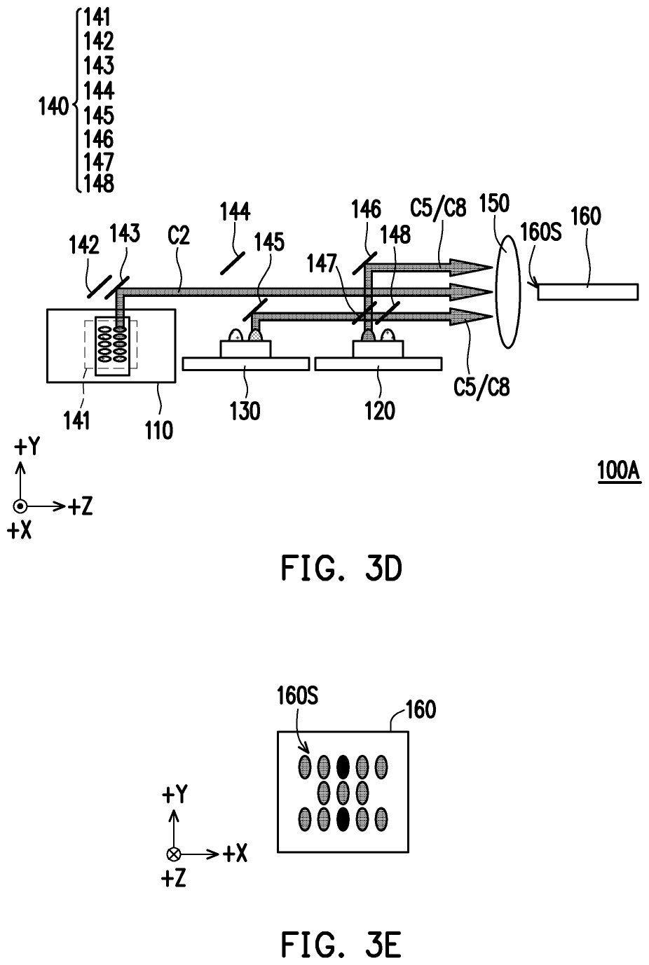

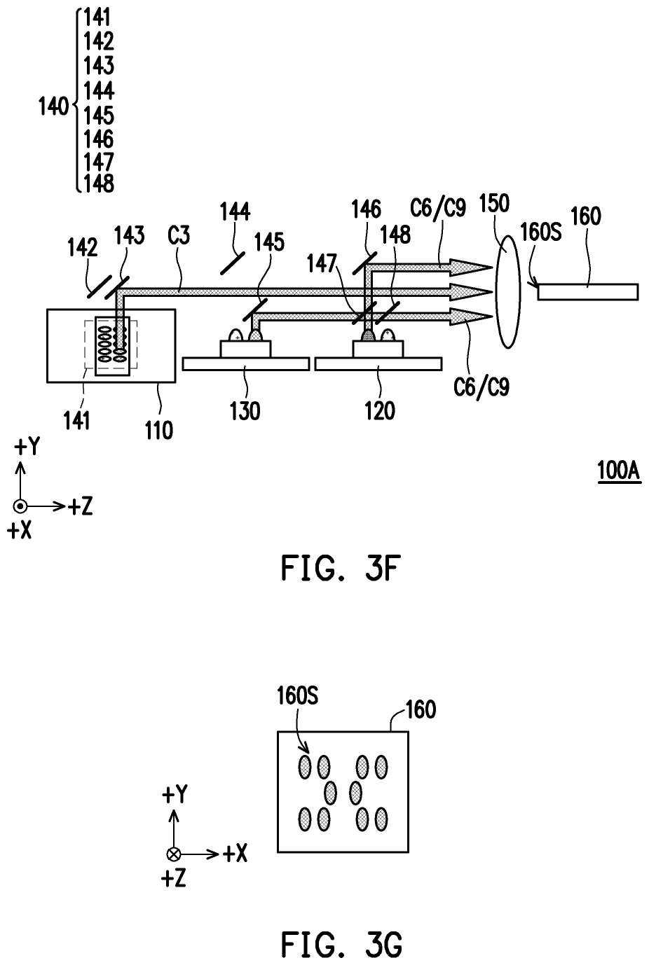

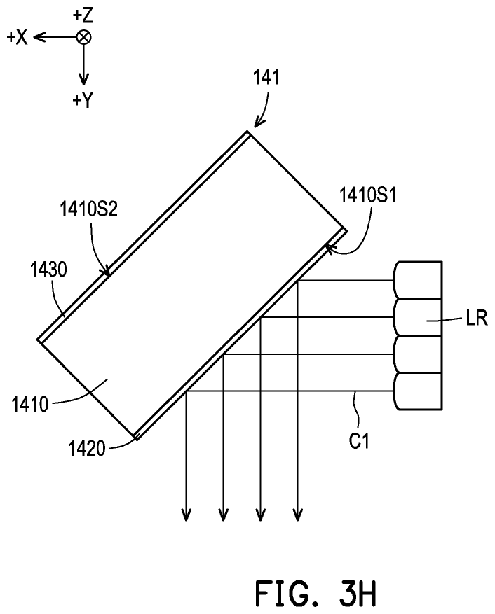

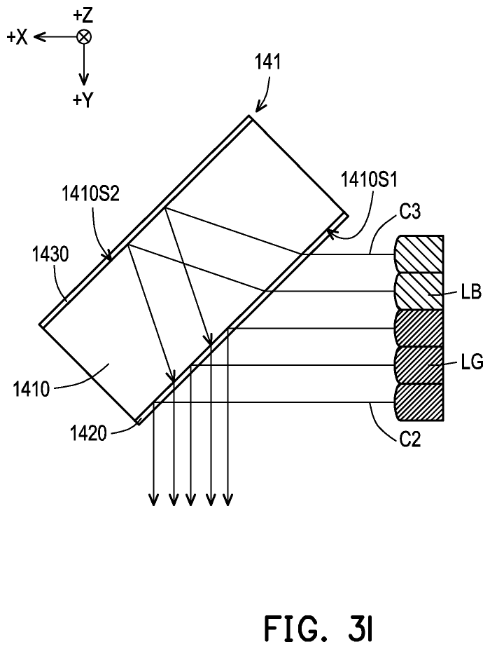

In the embodiment, the first light source module 110 is configured to generate a first beam L1. The second light source module 120 is configured to generate a second beam L2. The first light source module 110 and the second light source module 120 may respectively be a light emitting diode (LED) module, a laser diode module, or a combination thereof. The first light source module 110 and the second light source module 120 may respectively include multiple light sources, and the light sources are configured to emit beams of a single color or multiple colors. The first beam L1 includes at least one of a first color beam C1, a second color beam C2, and a third color beam C3. The second beam L2 includes at least one of a fourth color beam C4, a fifth color beam C5, and a sixth color beam C6. For example, as shown in FIG. 3A, the light sources respectively include at least one red light source LR, at least one green light source LG, and at least one blue light source LB. The least one red light source LR, the at least one green light source LG, and the at least one blue light source LB respectively provide the first color beam C1, the second color beam C2, and the third color beam C3. The first color beam C1, the second color beam C2, and the third color beam C3 may respectively be a red beam, a green beam, a blue beam, or a combination thereof. Similarly, the fourth color beam C4, the fifth color beam C5, and the sixth color beam C6 may also respectively be a red beam, a green beam, a blue beam, or a combination thereof.

In the embodiment, the first beam L1 is incident on the light combining module 140 along a first direction (for example, the +X direction of FIG. 3A). The light combining module 140 changes a transmission direction of the first beam L1 from the first direction to a second direction (for example, the +Y direction of FIG. 3A) and then to a third direction (for example, the +Z direction of FIG. 3A). The first beam L1 leaves the light combining module 140 along the third direction, wherein the first direction, the second direction, and the third direction are perpendicular to each other. The second beam L2 is incident on the light combining module 140 along the second direction. The light combining module 140 changes a transmission direction of the second beam L2 from the second direction to the third direction, and the second beam L2 leaves the light combining module 140.

In the embodiment, the first beam L1 and the second beam L2 from the light combining module 140 form the illumination beam IL. The illumination beam IL includes at least one of the first color beam C1, the second color beam C2, the third color beam C3, the fourth color beam C4, the fifth color beam C5, and the sixth color beam C6. For example, when the first color beam C1, the second color beam C2, and the third color beam C3 are respectively the red beam, the green beam, and the blue beam, and the fourth color beam C4, the fifth color beam C5, and the sixth color beam C6 are respectively the red beam, the green beam, and the blue beam, the illumination beam IL may be output as the red beam, the green beam, the blue beam, or a combination thereof at different timings.

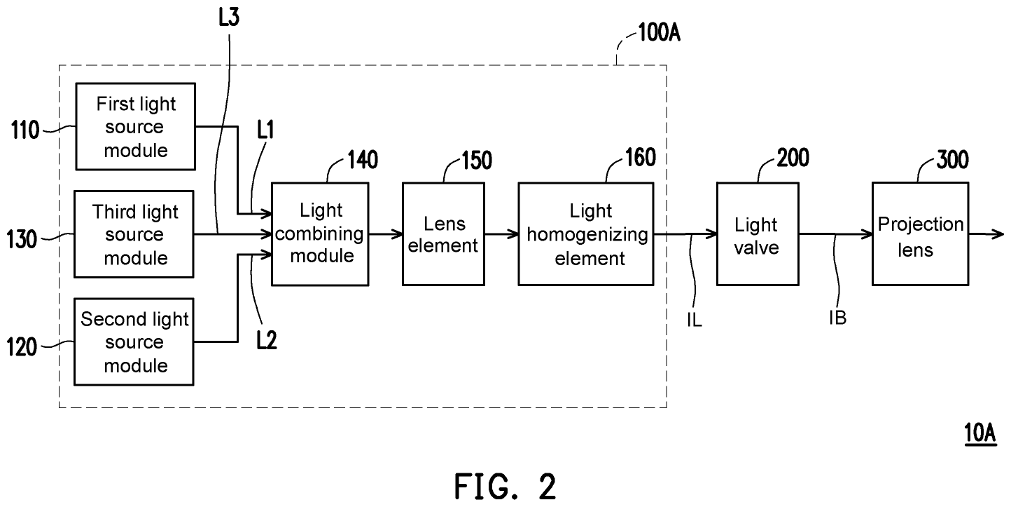

FIG. 2 is a schematic view of a projection device and an illumination system according to a second embodiment of the disclosure. FIG. 3A is a three-dimensional schematic view of the illumination system in FIG. 2. FIG. 3B is a schematic view of light paths of a first color beam, a fourth color beam, and a seventh color beam in the illumination system of FIG. 3A. FIG. 3C is a schematic view of a light spot distribution formed by the beams of FIG. 3B on a light incident surface of a light homogenizing element. FIG. 3D is a schematic view of light paths of a second color beam, a fifth color beam, and an eighth color beam in the illumination system of FIG. 3A. FIG. 3E is a schematic view of a light spot distribution formed by the beams of FIG. 3D on a light incident surface of a light homogenizing element. FIG. 3F is a schematic view of light paths of a third color beam, a sixth color beam, and a ninth color beam in the illumination system of FIG. 3A. FIG. 3G is a schematic view of a light spot distribution formed by the beams of FIG. 3F on a light incident surface of a light homogenizing element. The three-dimensional schematic view of FIG. 3A omits the illustration of a lens element 150 and a light homogenizing element 160.

Please refer to FIG. 2 to FIG. 3G. A projection device 10A and an illumination system 100A are similar to the projection device 10 and the illumination system 100 of FIG. 1, the main difference is as follows. In the embodiment, the illumination system 100A further includes a third light source module 130 for generating a third beam L3. The third beam L3 is incident on the light combining module 140 along the second direction. The light combining module 140 is configured to change a transmission direction of the third beam L3 from the second direction to the third direction, and the third beam L3 leaves the light combining module 140 along the third direction. The third beam L3 includes at least one of a seventh color beam C7, an eighth color beam C8, and a ninth color beam C9. The third light source module 130 may be a light emitting diode module, a laser diode module, or a combination thereof. The third light source module 130 may include multiple red light sources LR, green light sources LG, and blue light sources LB for emitting beams of a single color or multiple colors. For example, the seventh color beam C7, the eighth color beam C8, or the ninth color beam C9 may respectively be a red beam, a green beam, a blue beam, or a combination thereof.

In detail, the light combining module of the embodiment includes a light guiding element 141, a first mirror 142, and a first light splitting element 143. The light guiding element 141 is disposed on a transmission path of the first beam L1 from the first light source module 110. The light guiding element 141 is configured to change the transmission direction of the first beam L1 from the first direction (the +X direction) to the second direction (the +Y direction).

FIG. 3H is a schematic view of a light path of a first color beam at a light guiding element in FIG. 3A. FIG. 3I is a schematic view of light paths of a second color beam and a third color beam at a light guiding element in FIG. 3A. Please refer to FIG. 3H and FIG. 3I. In the embodiment, the light guiding element 141 includes a substrate 1410, a first optical layer 1420, and a second optical layer 1430. The first optical layer 1420 and the second optical layer 1430 are respectively disposed on a first optical surface 1410S1 and a second optical surface 1410S2 of the substrate 1410. The material of the substrate 1410 may be glass or other transparent materials. The materials of the first optical layer 1420 and the second optical layer 1430 may be titanium dioxide (TiO₂), silicon dioxide (SiO₂), or other suitable materials. When the first beam L1 is incident on the light guiding element 141, the first color beam C1 and the second color beam C2 of the first beam L1 are reflected by the first optical layer 1420 to leave the light guiding element 141, and the third color beam C3 of the first beam L1 passes through the first optical film 1420 to be transmitted in the substrate 1410. Then, the third color beam C3 of the first beam L1 is reflected by the second optical layer 1430 and then passes through the first optical layer 1420 to leave the light guiding element 141. In addition, as shown in FIG. 3I, the third color beam C3 is alternately arranged with the second color beam C2 after leaving the light guiding element 141, so beam concentration and uniformity can be achieved. The first optical layer 1420 may be a coating layer that reflects green light and red light and allows blue light to pass through. The second optical layer 1430 may be a coating layer or a mirror that reflects blue light.

In another embodiment, the substrate 1410 of the light guiding element 141 may include a first substrate and a second substrate, wherein the first substrate is located on a transmission path of the first color beam C1, and the second substrate is located on transmission paths of the second color beam C2 and the third color beam C3. The first substrate includes the first optical layer 1420. The first optical layer 1420 on the first substrate may be a coating layer or a mirror that reflects red light. The second substrate includes the first optical layer 1420 and the second optical layer 1430. The first optical layer 1420 on the second substrate may be a coating layer that reflects green light and allows blue light to pass through. The second optical layer 1430 may be a coating layer or a mirror that reflects blue light.

Please refer to FIG. 3A to FIG. 3G again. In the embodiment, the first mirror 142 is disposed on the transmission path of the first color beam C1 from the light guiding element 141. The first mirror 142 is configured to reflect the first color beam C1, so that a transmission direction of the first color beam C1 changes from the second direction to the third direction (the +Z direction).

In the embodiment, the first light splitting element 143 is disposed on the transmission path of the first color beam C1 from the first mirror 142 to allow the first color beam C1 to pass through. The first light splitting element 143 is disposed on the transmission paths of the second color beam C2 and the third color beam C3 from the light guiding element 141 to reflect the second color beam C2 and the third color beam C3, so that a transmission direction of the second color beam C2 and a transmission direction of the third color beam C3 change from the second direction to the third direction. The first light splitting element 143 includes, for example, a coating layer that reflects green light and blue light and allows red light to pass through.

In the embodiment, the light combining module 140 further includes a second light splitting element 146, a third light splitting element 147, and a fourth light splitting element 148. The second light splitting element 146 is disposed on transmission paths of the fifth color beam C5 and the sixth color beam C6 from the third light splitting element 147. The second light splitting element 146 is configured to reflect the fifth color beam C5 and the sixth color beam C6, so that a transmission direction of the fifth color beam C5 and a transmission direction of the sixth color beam C6 change from the second direction to the third direction. The second light splitting element 146 includes, for example, a coating layer that reflects green light and blue light and allows red light to pass through.

In the embodiment, the third light splitting element 147 is disposed on transmission paths of the fifth color beam C5 and the sixth color beam C6 from the second light source module 120. The third light splitting element 147 is configured to allow a part of the fifth color beam C5 and a part of the sixth color beam C6 to pass through to be transmitted to the second light splitting element 146, and the third light splitting element 147 is configured to reflect another part of the fifth color beam C5 and another part of the sixth color beam C6, so that a transmission direction of the another part of the fifth color beam C5 and a transmission direction of the another part of the sixth color beam C6 change from the second direction to the third direction. The third light splitting element 147 includes, for example, a coating layer that reflects half of green light and half of blue light and allows red light to pass through.

In the embodiment, the fourth light splitting element 148 is disposed on a transmission path of the fourth color beam C4 from the second light source module 120 to reflect the fourth color beam C4, so that a transmission direction of the fourth color beam C4 changes from the second direction to the third direction. The fourth light splitting element 148 is disposed on transmission paths of the another part of the fifth color beam C5 and the another part of the sixth color beam C6 from the third light splitting element 147 to allow the another part of the fifth color beam C5 and the another part of the sixth color beam C6 to pass through. The fourth light splitting element 148 includes, for example, a coating layer that reflects red light and allows green light and blue light to pass through.

In the embodiment, the light combining module 140 further includes a second mirror 144 and a third mirror 145. The second mirror 144 is disposed on a transmission path of the seventh color beam C7 from the third light source module 130 to reflect the seventh color beam C7, so that a transmission direction of the seventh color beam C7 changes from the second direction to the third direction to be transmitted to the second light splitting element 146.

In the embodiment, the third mirror 145 is disposed on transmission paths of the eighth color beam C8 and the ninth color beam C9 from the third light source module 130. The third mirror 145 is configured to reflect the eighth color beam C8 and the ninth color beam C9, so that a transmission direction of the eighth color beam C8 and a transmission direction of the ninth color beam C9 change from the second direction to the third direction, and the eighth color beam C8 and the ninth color beam C9 are transmitted to the third light splitting element 147.

In the embodiment, the third light splitting element 147 is also configured to reflect a part of the eighth color beam C8 and a part of the ninth color beam C9 to be transmitted to the second light splitting element 146, and the third light splitting element 147 is also configured to allow another part of the eighth color beam C8 and another part of the ninth color beam C9 to pass through to be transmitted to the fourth light splitting element 148.

In addition, the illumination system 100A further includes the light homogenizing element 160. In terms of the paths of the beams, the first color beam C1 is sequentially reflected by the light guiding element 141, reflected by the first mirror 142, and passes through the first light splitting element 143 to be transmitted to the light homogenizing element 160. The second color beam C2 and the third color beam C3 are sequentially reflected by the light guiding element 141 and reflected by the first light splitting element 143 to be transmitted to the light homogenizing element 160. The fourth color beam C4 is reflected by the fourth light splitting element 148 to be transmitted to the light homogenizing element 160. After the fifth color beam C5 and the sixth color beam C6 are transmitted to the third light splitting element 147, a part of the fifth color beam C5 and a part of the sixth color beam C6 sequentially pass through the third light splitting element 147 and are reflected by the second light splitting element 146 to be transmitted to the light homogenizing element 160, and another part of the fifth color beam C5 and another part of the sixth color beam C6 are sequentially reflected by the third light splitting element 147 and pass through the fourth light splitting element 148 to be transmitted to the light homogenizing element 160. Moreover, the seventh color beam C7 is sequentially reflected by the second mirror 144 and passes through the second light splitting element 146 to be transmitted to the light homogenizing element 160. The eighth color beam C8 and the ninth color beam C9 are sequentially reflected by the third mirror 145 to be transmitted to the third light splitting element 147. A part of the eighth color beam C8 and a part of the ninth color beam C9 are sequentially reflected by the third light splitting element 147 and reflected by the second light splitting element 146 to be transmitted to the light homogenizing element 160, and another part of the eighth color beam C8 and another part of the ninth color beam C9 sequentially pass through the third light splitting element 147 and the fourth light splitting element 148 to be transmitted to the light homogenizing element 160.

In the embodiment, along the second direction, light spots formed by the first beam L1 (the first color beam C1, the second color beam C2, and the third color beam C3) on the light homogenizing element 160 are located between light spots formed by the second beam L2 (the fourth color beam C4, the fifth color beam C5, and the sixth color beam C6) on the light homogenizing element 160 and light spots formed by the third beam L3 (the seventh color beam C7, the eighth color beam C8, and the ninth color beam C9) on the light homogenizing element 160, as shown in the schematic views of the light spot distributions on a light incident surface 160S of the light homogenizing element 160 in FIG. 3C, FIG. 3E, and FIG. 3G. The light spot distributions of the fifth color beam C5 and the eighth color beam C8 have overlapping regions, as shown in FIG. 3E. In the schematic view of the light spot distribution of FIG. 3E, the brightness of the middle light spots in the upper and lower rows of light spots is higher than that of other light spots.

In the embodiment, the light spots formed by the first color beam C1, the fourth color beam C4, and the seventh color beam C7 on the light homogenizing element 160 are axisymmetric in the first direction and the second direction, as shown in FIG. 3C. The light spots formed by the second color beam C2, the fifth color beam C5, and the eighth color beam C8 on the light homogenizing element 160 are axisymmetric in the first direction and the second direction, as shown in FIG. 3E. Moreover, the light spots formed by the third color beam C3, the sixth color beam C6, and the ninth color beam C9 on the light homogenizing element 160 are axisymmetric in the first direction and the second direction, as shown in FIG. 3G.

In the embodiment, a distance d1 from the second light source module 120 to an optical axis 160C of the light homogenizing element 160 is the same as a distance d2 from the third light source module 130 to the optical axis 160C of the light homogenizing element 160.

In the embodiment, the illumination system 100A further includes the lens element 150, which is disposed between the light combining module 140 and the light homogenizing element 160 on the optical paths of the first color beam C1 to the ninth color beam C9. The lens element 150 is, for example, a focusing lens element for focusing the first color beam C1 to the ninth color beam C9 on the light homogenizing element 160. An orthographic projection of the first light splitting element 143 on the lens element 150 is located between orthographic projections of the second light splitting element 146 and the third light splitting element 147 on the lens element 150. In addition, an orthographic projection of the first mirror 142 on the lens element 150 is located between orthographic projections of the second mirror 144 and the third mirror 145 on the lens element 150. More specifically, the orthographic projections of the first mirror 142 and the first light splitting element 143 on the lens element 150 are located between the orthographic projections of the second mirror 144, the third mirror 145, the second light splitting element 146, the third light splitting element 147, and the fourth light splitting element 148 on the lens element 150.

In addition, in the embodiment, the second light source module 120 and the third light source module 130 are located on the same side of the optical axis 160C of the light homogenizing element 160. Therefore, the second light source module 120 and the third light source module 130 may share a heat dissipating element (for example, heat dissipating fins) to simplify the design of the illumination system 100A. In addition, along the second direction, the green light source LG and/or the blue light source LB in the second light source module 120 and the third light source module 130 are adjacent to each other. Distances respectively between the first light source module 110, the second light source module 120, and the third light source module 130 and the lens element 150 are different.

Based on the above, in the illumination system 100A or the projection device 10A of the embodiment, the optical path in the illumination system 100A is designed such that the light combining module 140 changes the transmission direction of the first beam L1 from the first direction to the second direction and then to the third direction, and the first beam L1 leaves the light combining module 140, and the light combining module 140 changes the transmission direction of the second beam L2 from the second direction to the third direction, and the second beam L2 leaves the light combining module 140. Therefore, the angular distribution and spatial distribution of the illumination beam IL emitted from the light combining module 140 is symmetrical, so that the color uniformity and the brightness uniformity of the illumination beam IL generated by the illumination system 100A or the image beam IB generated by the projection device 10A are better. Moreover, due to the symmetry of the angular distribution and spatial distribution of the illumination beam IL, the etendue of the illumination beam IL is reduced, thereby increasing the brightness of the illumination beam IL.

Besides, in an embodiment, the illumination system 100A or the projection device 10A further includes the third light source module 130 and the second mirror 144 and the third mirror 145 disposed corresponding to the third beam L3. Therefore, the angular and spatial distribution of the illumination beam IL after emitting from the light combining module 140 is more axisymmetric, thereby enhancing the color uniformity of the illumination beam IL or the image beam IB.

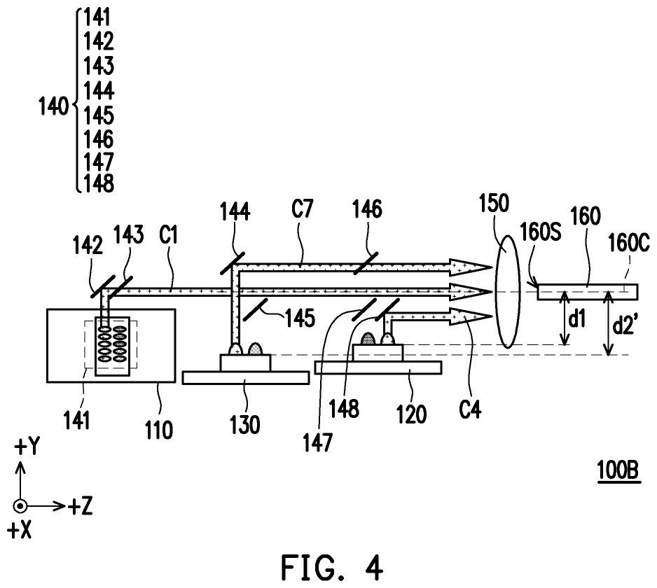

FIG. 4 is a schematic view of an illumination system according to a third embodiment of the disclosure. FIG. 4 only shows the light paths of the first color beam C1, the fourth color beam C4, and the seventh color beam C7. Please refer to FIG. 4. An illumination system 100B is similar to the illumination system 100A, and the main difference is as follows. In the embodiment, the distance d1 from the second light source module 120 to the optical axis 160C of the light homogenizing element 160 may be different from a distance d2′ from the third light source module 130 to the optical axis 160C of the light homogenizing element 160. The advantages of the illumination system 100B are similar to those of the illumination system 100A and will not be repeated here.

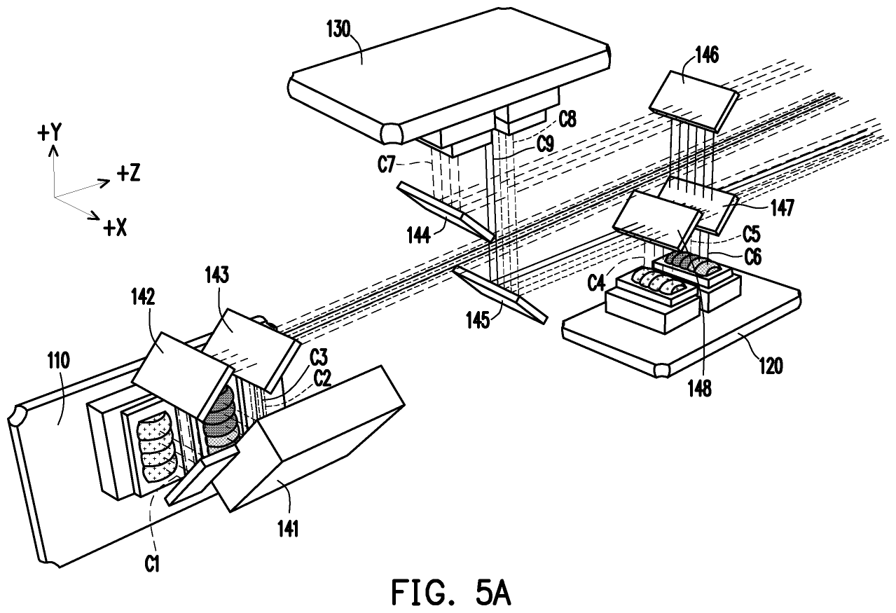

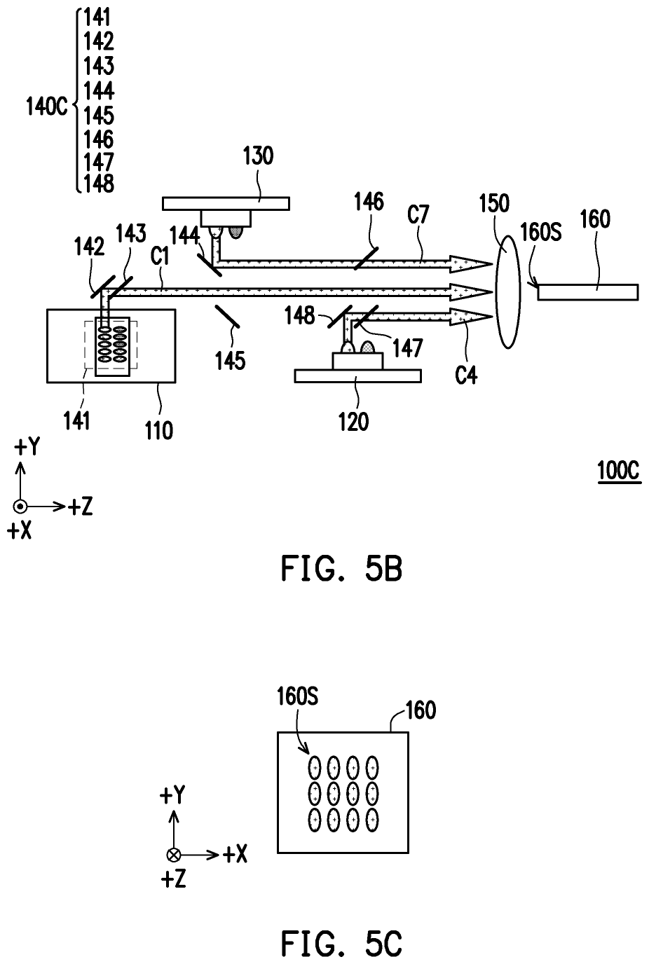

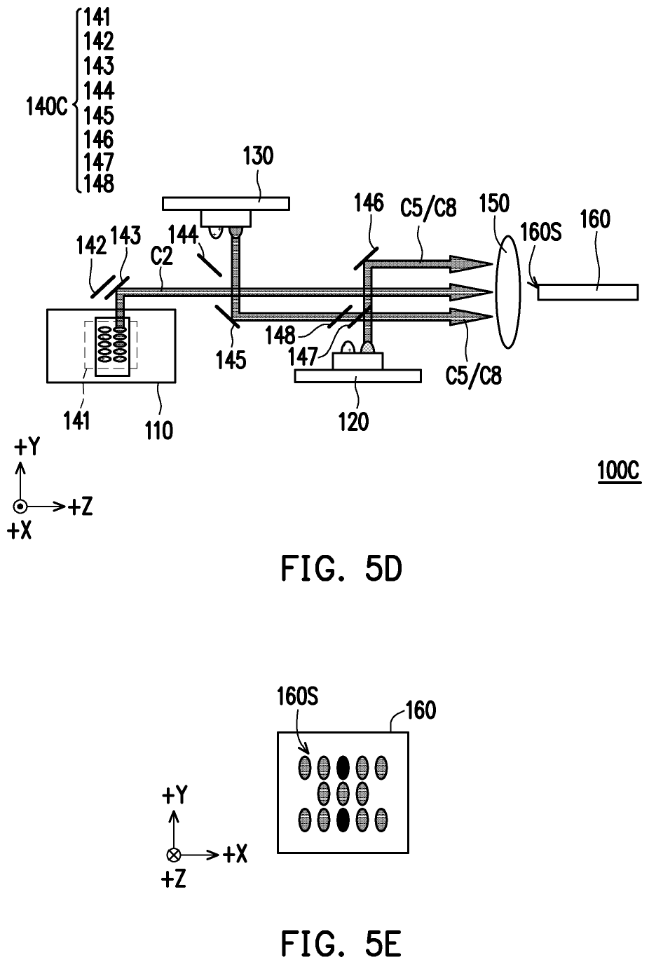

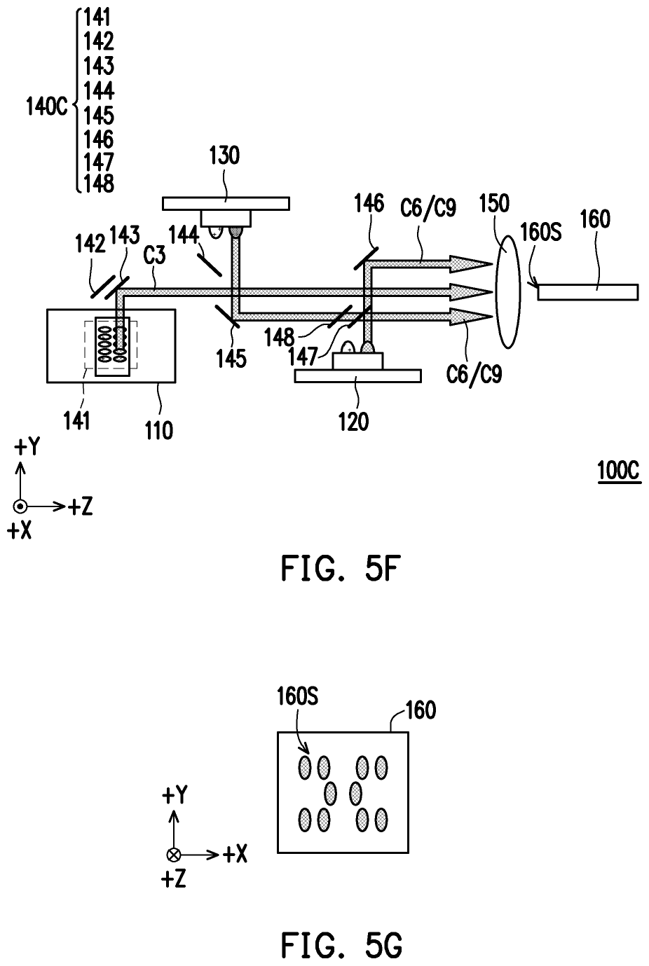

FIG. 5A is a three-dimensional schematic view of an illumination system according to a fourth embodiment of the disclosure. FIG. 5B is a schematic view of light paths of a first color beam, a fourth color beam, and a seventh color beam in the illumination system of FIG. 5A. FIG. 5C is a schematic view of a light spot distribution formed by the beams of FIG. 5B on a light incident surface of a light homogenizing element. FIG. 5D is a schematic view of light paths of a second color beam, a fifth color beam, and an eighth color beam in the illumination system of FIG. 5A. FIG. 5E is a schematic view of a light spot distribution formed by the beams of FIG. 5D on a light incident surface of a light homogenizing element. FIG. 5F is a schematic view of light paths of a third color beam, a sixth color beam, and a ninth color beam in the illumination system of FIG. 5A. FIG. 5G is a schematic view of a light spot distribution formed by the beams of FIG. 5F on a light incident surface of a light homogenizing element. The three-dimensional schematic view of FIG. 5A omits the illustration of the lens element 150 and the light homogenizing element 160.

Please refer to FIG. 5A to FIG. 5G. An illumination system 100C is similar to the illumination system 100A, and the main difference is as follows. In the embodiment, the third light splitting element 147 is also disposed on a transmission path of the fourth color beam C4 from the fourth light splitting element 148 to allow the fourth color beam C4 to pass through. The eighth color beam C8 and the ninth color beam C9 from the third mirror 145 are transmitted to the fourth light splitting element 148.

In addition, in the embodiment, the second light source module 120 and the third light source module 130 are respectively located on two opposite sides of the optical axis 160C of the light homogenizing element 160. On a reference plane parallel to YZ, the second light source module 120 and the third light source module 130 are misaligned. On a reference plane parallel to XZ, an orthographic projection of the second light source module 120 on the reference plane and an orthographic projection of the third light source module 130 on the reference plane at least partially overlap. Therefore, the length of the illumination system 100C of the embodiment in the Z direction is shorter, and the illumination system 100C has the advantage of being small in volume. Moreover, the red light source LR in the second light source module 120 is adjacent to the blue light source LB and the green light source LG in the third light source module 130. Other advantages of the illumination system 100C are similar to those of the illumination system 100A and will not be repeated here.

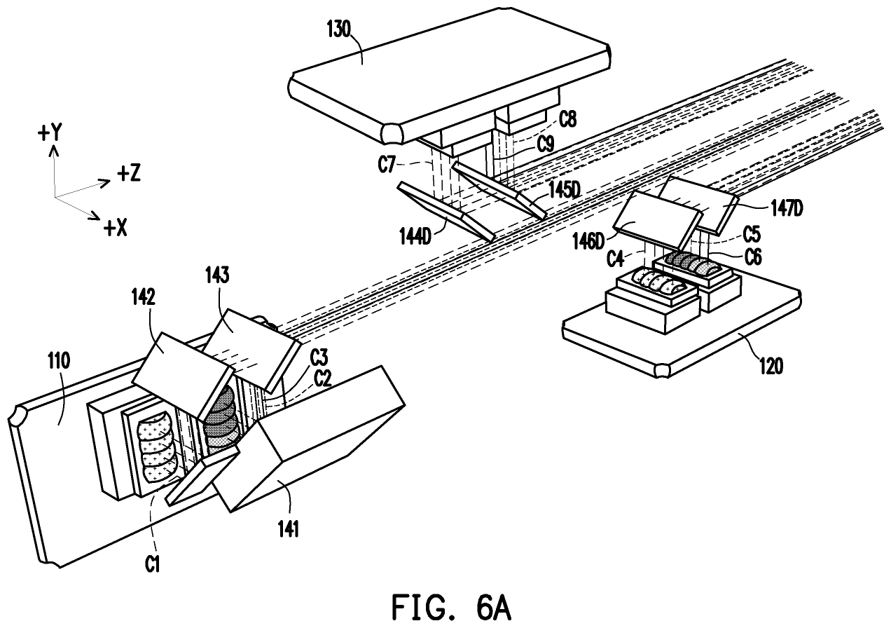

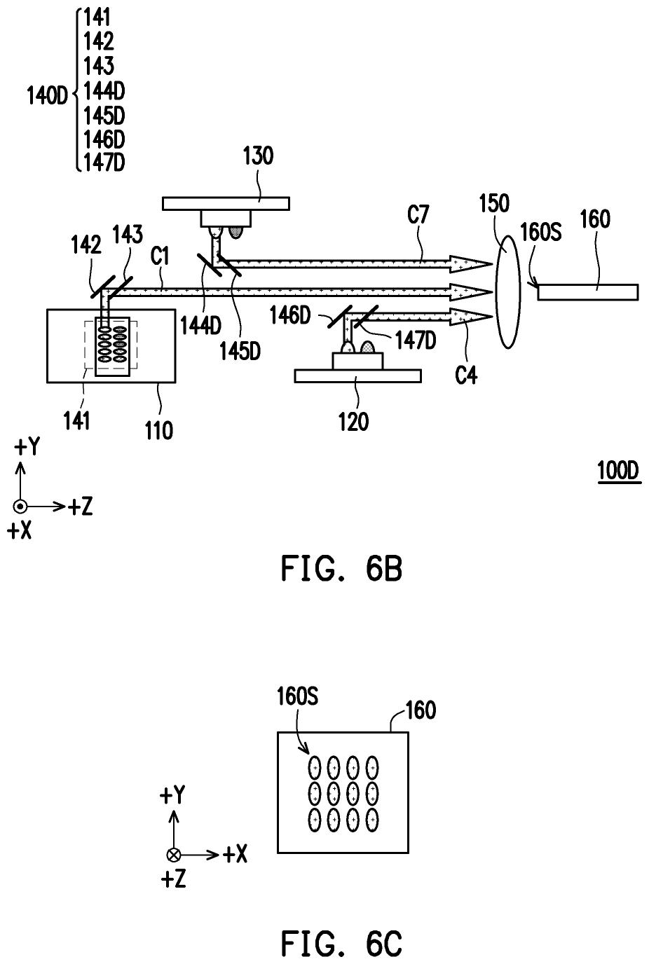

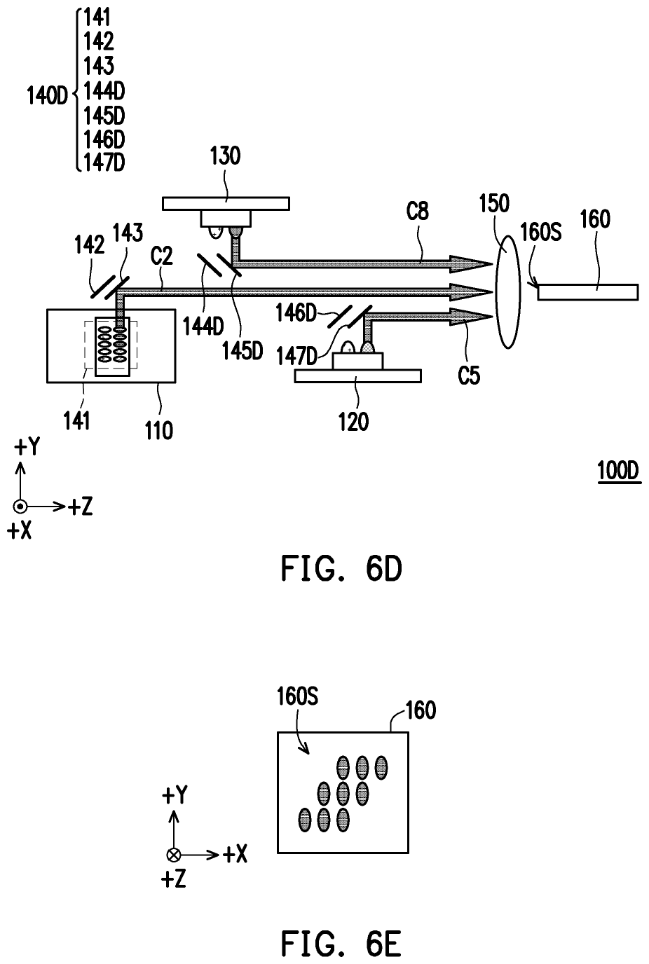

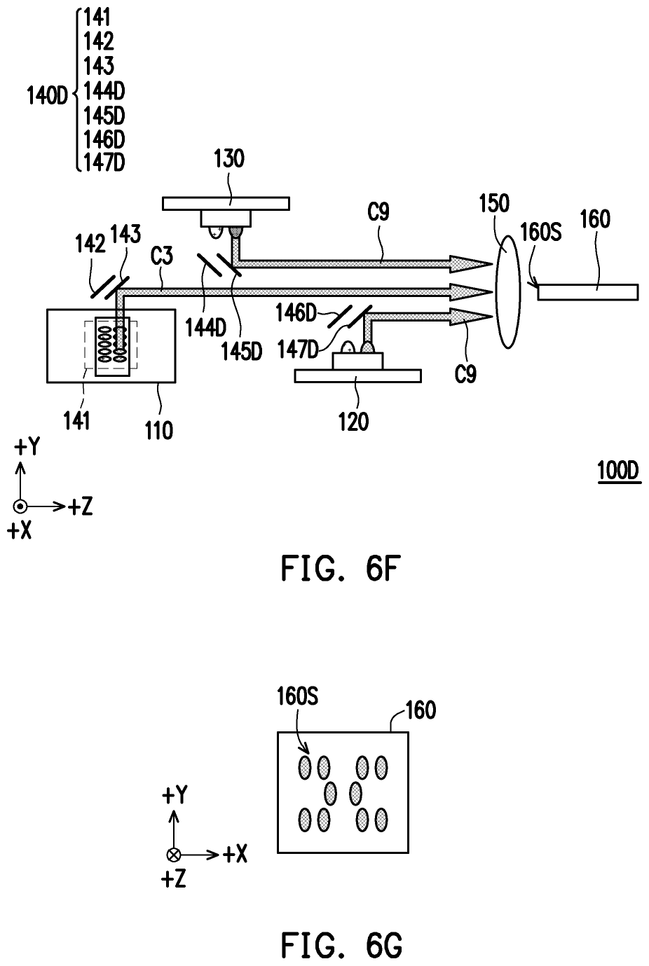

FIG. 6A is a three-dimensional schematic view of an illumination system according to a fifth embodiment of the disclosure. FIG. 6B is a schematic view of light paths of a first color beam, a fourth color beam, and a seventh color beam in the illumination system of FIG. 6A. FIG. 6C is a schematic view of a light spot distribution formed by the beams of FIG. 6B on a light incident surface of a light homogenizing element. FIG. 6D is a schematic view of light paths of a second color beam, a fifth color beam, and an eighth color beam in the illumination system of FIG. 6A. FIG. 6E is a schematic view of a light spot distribution formed by the beams of FIG. 6D on a light incident surface of a light homogenizing element. FIG. 6F is a schematic view of light paths of a third color beam, a sixth color beam, and a ninth color beam in the illumination system of FIG. 6A. FIG. 6G is a schematic view of a light spot distribution formed by the beams of FIG. 6F on a light incident surface of a light homogenizing element. The three-dimensional schematic view of FIG. 6A omits the illustration of the lens element 150 and the light homogenizing element 160.

Please refer to FIG. 6A to FIG. 6G. An illumination system 100D is similar to the illumination system 100C, and the main difference is as follows. In the embodiment, a second mirror 146D of a light combining module 140D is disposed on the transmission path of the fourth color beam C4 from the second light source module 120 to reflect the fourth color beam C4, so that the transmission direction of the fourth color beam C4 changes from the second direction to the third direction, and the fourth color beam C4 is transmitted to a second light splitting element 147D.

In the embodiment, the second light splitting element 147D is disposed on a transmission path of the fourth color beam C4 from the second mirror 146D to allow the fourth color beam C4 to pass through. The second light splitting element 147D is disposed on the transmission paths of the fifth color beam C5 and the sixth color beam C6 from the second light source module 120 to reflect the fifth color beam C5 and the sixth color beam C6, so that the transmission direction of the fifth color beam C5 and the transmission direction of the sixth color beam C6 change from the second direction to the third direction. The second light splitting element 147D includes, for example, a coating layer that reflects green light and blue light and allows red light to pass through.

In the embodiment, the light combining module 140D further includes a third mirror 144D and a third light splitting element 145D. The third mirror 144D is disposed on the transmission path of the seventh color beam C7 from the third light source module 130 to reflect the seventh color beam C7, so that the transmission direction of the seventh color beam C7 changes from the second direction to the third direction, and the seventh color beam C7 is transmitted to the third light splitting element 145D.

In the embodiment, the third light splitting element 145D is disposed on a transmission path of the seventh color beam C7 from the third mirror 144D to allow the seventh color beam C7 to pass through. The third light splitting element 145D is disposed on the transmission paths of the eighth color beam C8 and the ninth color beam C9 from the third light source module 130 to reflect the eighth color beam C8 and the ninth color beam C9, so that the transmission direction of the eighth color beam C8 and the transmission direction of the ninth color beam C9 change from the second direction to the third direction. The third light splitting element 145D includes, for example, a coating layer that reflects green light and blue light and allows red light to pass through.

Based on the above, since the optical elements in the light combining module 140D of the illumination system 100D are less than the optical elements in the light combining module 140C, the illumination system 100D can further reduce production costs.

In summary, in the illumination system or the projection device according to an embodiment of the disclosure, the light combining module is configured to change the transmission direction of the first beam from the first direction to the second direction and then to the third direction, and the first beam leaves the light combining module, and the light combining module changes the transmission direction of the second beam from the second direction to the third direction, and the second beam leaves the light combining module. Therefore, the angular distribution and spatial distribution of the first beam and the second beam after emitting from the light combining module are symmetrical, so that the color uniformity of the illumination beam or the image beam generated by the illumination system or the projection device is better.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. An illumination system, comprising a first light source module, a second light source module, and a light combining module, and the illumination system being configured to provide an illumination beam, wherein:
the first light source module is configured to generate a first beam, the first beam is incident on the light combining module along a first direction, and the light combining module is configured to change a transmission direction of the first beam from the first direction to a second direction and then to a third direction, and the first beam leaves the light combining module along the third direction, wherein the first direction, the second direction, and the third direction are perpendicular to each other;
the second light source module is configured to generate a second beam, the second beam is incident on the light combining module along the second direction, and the light combining module is configured to change a transmission direction of the second beam from the second direction to the third direction, and the second beam leaves the light combining module along the third direction; and
the first beam and the second beam leaving the light combining module form the illumination beam, wherein the first beam comprises at least one of a first color beam, a second color beam, and a third color beam, and the second beam comprises at least one of a fourth color beam, a fifth color beam, and a sixth color beam.

2. The illumination system according to claim 1, wherein the light combining module comprises a light guiding element, a first mirror, and a first light splitting element, wherein:
the light guiding element is disposed on a transmission path of the first beam from the first light source module, and the light guiding element is configured to change the transmission direction of the first beam from the first direction to the second direction;
the first mirror is disposed on a transmission path of the first color beam of the first beam from the light guiding element, and is configured to reflect the first color beam and change the transmission direction of the first color beam from the second direction to the third direction; and
the first light splitting element is disposed on a transmission path of the first color beam from the first mirror and is configured to allow the first color beam to pass through, and the first light splitting element is disposed on transmission paths of the second color beam and the third color beam of the first beam from the light guiding element and is configured to reflect the second color beam and the third color beam and change the transmission direction of the second color beam and a transmission direction of the third color beam from the second direction to the third direction.

3. The illumination system according to claim 2, wherein the light guiding element comprises a first optical layer and a second optical layer, when the first beam is incident on the light guiding element, the first color beam and the second color beam are reflected by the first optical layer to leave the light guiding element, and the third color beam is reflected by the second optical layer after passing through the first optical layer and then passes through the first optical layer to leave the light guiding element.

4. The illumination system according to claim 2, wherein the light combining module further comprises a second light splitting element and a third light splitting element, wherein:
the second light splitting element is disposed on transmission paths of the fifth color beam and the sixth color beam of the second beam, and is configured to reflect the fifth color beam and the sixth color beam; and
the third light splitting element is disposed on transmission paths of the fifth color beam and the sixth color beam of the second beam from the second light source module, the third light splitting element is configured to allow a part of the fifth color beam and a part of the sixth color beam to pass through to be transmitted to the second light splitting element, and the third light splitting element is configured to reflect another part of the fifth color beam and another part of the sixth color beam.

5. The illumination system according to claim 4, wherein the light combining module further comprises a fourth light splitting element, the fourth light splitting element is disposed on a transmission path of the fourth color beam of the second beam from the second light source module and is configured to reflect the fourth color beam, and the fourth light splitting element is disposed on transmission paths of the another part of the fifth color beam and the another part of the sixth color beam from the third light splitting element and is configured to allow the another part of the fifth color beam and the another part of the sixth color beam to pass through.

6. The illumination system according to claim 4, further comprising: a third light source module, configured to generate a third beam, wherein the third beam is incident on the light combining module along the second direction, and the light combining module is configured to change as transmission direction of the third beam from the second direction to the third direction to leave the light combining module, wherein the third beam comprises at least one of a seventh color beam, an eighth color beam, and a ninth color beam.

7. The illumination system according to claim 6, wherein the light combining module further comprises a second mirror and a third mirror, wherein:
the second mirror is disposed on a transmission path of the seventh color beam from the third light source module, and the second mirror is configured to reflect the seventh color beam and changes a transmission direction of the seventh color beam from the second direction to the third direction, and the seventh color beam is transmitted to the second light splitting element;
the third mirror is disposed on transmission paths of the eighth color beam and the ninth color beam from the third light source module, and the third mirror is configured to reflect the eighth color beam and the ninth color beam and change a transmission direction of the eighth color beam and a transmission direction of the ninth color beam from the second direction to the third direction, and the eighth color beam and the ninth color beam are transmitted to the third light splitting element.

8. The illumination system according to claim 7, further comprising: a lens element, wherein an orthographic projection of the first mirror on the lens element is located between orthographic projections of the second mirror and the third mirror on the lens element.

9. The illumination system according to claim 6, wherein the third light splitting element is also configured to reflect a part of the eighth color beam and a part of the ninth color beam to be transmitted to the second light splitting element, and the third light splitting element is also configured to allow another part of the eighth color beam and another part of the ninth color beam to pass through.

10. The illumination system according to claim 6, further comprising:
a light homogenizing element, wherein along the second direction, a light spot formed by the first beam on the light homogenizing element is located between light spots formed by the second beam and the third beam on the light homogenizing element.

11. The illumination system according to claim 10, wherein light spots formed by the first color beam, the fourth color beam, and the seventh color beam on the light homogenizing element are axisymmetric in the first direction and the second direction.

12. The illumination system according to claim 10, wherein light spots formed by the second color beam, the fifth color beam, and the eighth color beam on the light homogenizing element are axisymmetric in the first direction and the second direction.

13. The illumination system according to claim 10, wherein light spots formed by the third color beam, the sixth color beam, and the ninth color beam on the light homogenizing element are axisymmetric in the first direction and the second direction.

14. The illumination system according to claim 6, further comprising: a light homogenizing element, wherein a distance from the second light source module to an optical axis of the light homogenizing element is the same as a distance from the third light source module to the optical axis of the light homogenizing element.

15. The illumination system according to claim 6, further comprising: a light homogenizing element, wherein a distance from the second light source module to an optical axis of the light homogenizing element is different from a distance from the third light source module to the optical axis of the light homogenizing element.

16. The illumination system according to claim 6, wherein the second light source module and the third light source module respectively comprise a blue light source, and along the second direction, the blue light sources of the second light source module and the third light source module are adjacent to each other.

17. The illumination system according to claim 6, further comprising: a light homogenizing element, wherein the second light source module and the third light source module are respectively located on two opposite sides of an optical axis of the light homogenizing element.

18. The illumination system according to claim 2, wherein the light combining module further comprises a second mirror and a second light splitting element, wherein:
the second mirror is disposed on a transmission path of the fourth color beam of the second beam from the second light source module, and is configured to reflect the fourth color beam and change the transmission direction of the fourth color beam from the second direction to the third direction; and
the second light splitting element is disposed on a transmission path of the fourth color beam from the second mirror and is configured to allow the fourth color beam to pass through, and the second light splitting element is disposed on transmission paths of the fifth color beam and the sixth color beam of the second beam from the second light source module and is configured to reflect the fifth color beam and the sixth color beam.

19. The illumination system according to claim 18, further comprising: a third light source module, configured to generate a third beam, wherein the third beam comprises at least one of a seventh color beam, an eighth color beam, and a ninth color beam, and the light combining module further comprises a third mirror and a third light splitting element, wherein:
the third mirror is disposed on a transmission path of the seventh color beam from the third light source module, and is configured to reflect the seventh color beam and changes a transmission direction of the seventh color beam from the second direction to the third direction; and
the third light splitting element is disposed on a transmission path of the seventh color beam from the third mirror and is configured to allow the seventh color beam to pass through, and the third light splitting element is disposed on transmission paths of the eighth color beam and the ninth color beam from the third light source module and is configured to reflect the eighth color beam and the ninth color beam and change a transmission direction of the eighth color beam and a transmission direction of the ninth color beam from the second direction to the third direction.

20. A projection device, comprising: an illumination system, a light valve, and a projection lens, wherein the illumination system comprises a first light source module, a second light source module, and a light combining module, the illumination system is configured to provide an illumination beam, the light valve is disposed on a transmission path of the illumination beam and is configured to convert the illumination beam into an image beam, and the projection lens is disposed on a transmission path of the image beam and is configured to project the image beam out of the projection device, wherein:
the first light source module is configured to generate a first beam, the first beam is incident on the light combining module along a first direction, and the light combining module is configured to change a transmission direction of the first beam from the first direction to a second direction and then to a third direction, and the first beam leaves the light combining module, wherein the first direction, the second direction, and the third direction are perpendicular to each other;
the second light source module is configured to generate a second beam, the second beam is incident on the light combining module along the second direction, and the light combining module is configured to change a transmission direction of the second beam from the second direction to the third direction, and the second beam leaves the light combining module; and
the first beam and the second beam leaving the light combining module form the illumination beam, wherein the first beam comprises at least one of a first color beam, a second color beam, and a third color beam, and the second beam comprises at least one of a fourth color beam, a fifth color beam, and a sixth color beam.
